(19) United States
(12) Patent Application Publication
(10) Pub. No.: US 2025/0116497 A1
(43) Pub. Date: Apr. 10, 2025

(54) CALIBRATION DATA ACQUISITION METHOD AND INSPECTION GAUGE

(71) Applicant: MITUTOYO CORPORATION, Kanagawa (JP)

(72) Inventor: Yuto INOUE, Ibaraki (JP)

(73) Assignee: MITUTOYO CORPORATION, Kanagawa (JP)

(21) Appl. No.: 18/895,946

(22) Filed: Sep. 25, 2024

(30) Foreign Application Priority Data
Oct. 6, 2023 (JP) 2023-174394

(51) Int. Cl. G01B 5/008

(52) U.S. Cl. CPC G01B 5/008

(57) ABSTRACT

A calibration data acquisition method includes: a first holding step of holding an inspection gauge provided with a plurality of portions to be examined in a first posture with a gauge moving apparatus; a first measuring step of acquiring first distance data by measuring a distance between the plurality of portions to be examined with the three-dimensional measuring apparatus; a second holding step of holding the inspection gauge in a second posture with the gauge moving apparatus, after the first measuring step; a second measuring step of acquiring second distance data by measuring a distance between the plurality of portions to be examined of the inspection gauge in the second posture with the three-dimensional measuring apparatus; and a step of generating calibration data including the first distance data and the second distance data.

### CROSS-REFERENCE TO RELATED APPLICATIONS

The present application claims priority to Japanese Patent Application number 2023-174394, filed on Oct. 6, 2023. The contents of this application are incorporated herein by reference in their entirety.

### BACKGROUND OF THE INVENTION

The present disclosure relates to a calibration data acquisition method and an inspection gauge. A three-dimensional measuring apparatus is known for measuring the dimensions, geometries, and other characteristics of measurement targets. The three-dimensional measuring apparatus is calibrated using an inspection gauge to maintain measurement accuracy. For example, Japanese Unexamined Patent Application Publication No. 2023-017309 discloses an inspection gauge provided with spheres at positions corresponding to the vertexes of a triangular pyramid.

In the configuration of Japanese Unexamined Patent Application Publication No. 2023-017309, it is necessary to prepare an inspection gauge with a relatively complicated structure to acquire sufficient calibration data for calibrating the three-dimensional measuring apparatus.

### BRIEF SUMMARY OF THE INVENTION

The present disclosure has been made in view of these points, and its object is to provide a calibration data acquisition method and an inspection gauge capable of simplifying the structure of the inspection gauge used for calibrating a three-dimensional measuring apparatus.

A calibration data acquisition method according to one aspect of the present disclosure includes: a first holding step of holding an inspection gauge provided with a plurality of portions to be examined in a first posture with a gauge moving apparatus, in a measurement space of a three-dimensional measuring apparatus; a first measuring step of acquiring first distance data by measuring a distance between the plurality of portions to be examined of the inspection gauge in the first posture, with the three-dimensional measuring apparatus; a second holding step of holding the inspection gauge in a second posture that is different from the first posture with the gauge moving apparatus, after the first measuring step; a second measuring step of acquiring second distance data by measuring a distance between the plurality of portions to be examined of the inspection gauge in the second posture, with the three-dimensional measuring apparatus; and a step of generating calibration data including at least the first distance data and the second distance data.

An inspection gauge according to one aspect of the present disclosure is an inspection gauge including a support, and a plurality of portions to be examined provided on the support such that the plurality of portions to be examined are arranged on a straight line along an extending direction of the support, wherein the plurality of portions to be examined include a first portion to be examined, a second portion to be examined, and a third portion to be examined, and i) a first distance between the first portion to be examined and the second portion to be examined and ii) a second distance between the second portion to be examined and the third portion to be examined are different from each other.

### BRIEF DESCRIPTION OF THE DRAWINGS

FIG. 1 shows a system according to one embodiment of the present disclosure.

FIG. 2 is a block diagram showing configurations of a three-dimensional measuring apparatus and a gauge moving apparatus.

FIG. 3 shows an example of an inspection gauge.

FIG. 4 shows an example of a conventional inspection gauge.

FIG. 5 is a flowchart of an example of a calibration data acquisition method using the inspection gauge of FIG. 4.

FIGS. 6A and 6B are each a schematic diagram for explaining the calibration data acquisition method.

FIG. 7 shows an inspection gauge according to a second embodiment.

FIG. 8 is a cross-sectional view of a part of the inspection gauge of FIG. 7.

FIG. 9 shows a variation example of the inspection gauge.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### First Embodiment

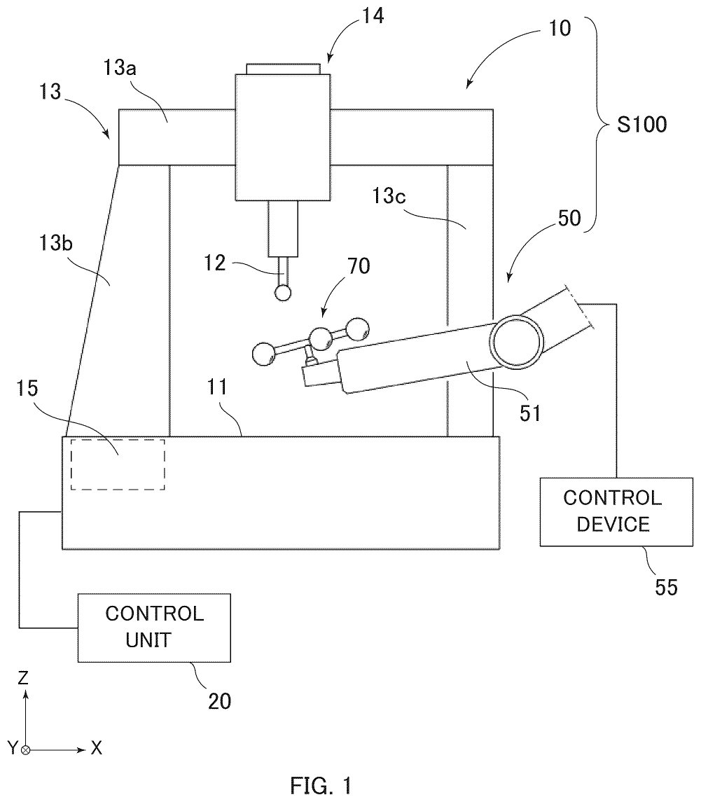

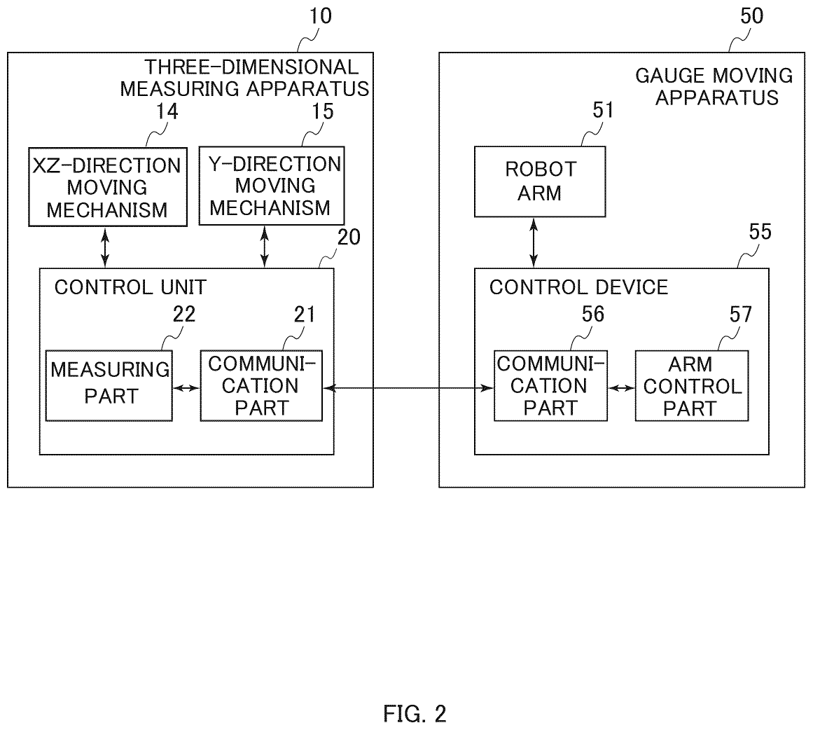

FIG. 1 shows a system according to one embodiment of the present disclosure. FIG. 2 is a block diagram showing configurations of a three-dimensional measuring apparatus and a gauge moving apparatus.

As shown in FIG. 1, a system S100 includes a three-dimensional measuring apparatus 10 and a gauge moving apparatus 50. A main feature of the system S100 is to generate calibration data of the three-dimensional measuring apparatus 10, by moving an inspection gauge 70 into a plurality of postures with the gauge moving apparatus 50 and measuring the position of a portion to be examined of the inspection gauge 70 in each posture with the three-dimensional measuring apparatus 10. According to such a configuration, it is possible to simplify the inspection gauge, compared to a complex gauge in the prior art.

### (The Three-Dimensional Measuring Apparatus 10)

The three-dimensional measuring apparatus 10 has a table 11, a probe 12, a support mechanism 13, an XZ-direction moving mechanism 14, a Y-direction moving mechanism 15, and a control unit 20.

The table 11 has a horizontal placement surface on which a workpiece serving as an object to be measured can be placed. The probe 12 is held by a part of the XZ-direction moving mechanism 14. The probe 12 extends in the Z direction in this example. A sphere is provided at the tip of the probe 12.

The support mechanism 13 is a mechanism that supports the XZ-direction moving mechanism 14. The support mechanism 13 has a beam 13a, a column 13b, and a supporter 13c, and constitutes a gate-shaped frame. The support mechanism 13 is provided to be movable in the Y direction.

The beam 13a is a member extending in the X direction above the table 11. The beam 13a supports the XZ-direction moving mechanism 14. The column 13b and the supporter 13c are members for supporting the beam 13a. Both the column 13b and the supporter 13c extend in the Z direction.

The XZ-direction moving mechanism 14 moves the probe 12 in the X direction and the Z direction. The XZ-direction moving mechanism 14 may have a driving unit (not shown) that tilts the probe 12 in one or a plurality of directions intersecting the Z direction. The XZ-direction moving mechanism 14 is configured to be movable in the X direction along the beam 13a. The Y-direction moving mechanism 15 moves the support mechanism 13 in the Y direction. The XZ-direction moving mechanism 14 and the Y-direction moving mechanism 15 operate to move the probe 12 to any position in the measurement space of the three-dimensional measuring apparatus 10.

The control unit 20 is a computer that controls the operation of each part of the three-dimensional measuring apparatus 10. As shown in FIG. 2, the control unit 20 has a communication part 21 and a measuring part 22. The control unit 20 controls the position of the probe 12 in order to measure a plurality of portions to be examined in the inspection gauge 70. The control unit 20 measures a plurality of positions to be measured by moving the probe 12 to the inspection gauge 70 on the basis of coordinates indicating a preset position to be measured.

The communication part 21 includes a communication device for transmitting and receiving information via a network, for example. The communication part 21 receives an arrangement completion notification indicating that the inspection gauge 70 has been arranged in a predetermined posture, which has been transmitted by the gauge moving apparatus 50. The communication part 21 transmits, to the gauge moving apparatus 50, a measurement completion notification indicating that the three-dimensional measuring apparatus 10 has completed measurement of the plurality of portions to be examined of the inspection gauge 70.

The measuring part 22 measures the plurality of positions to be measured of the inspection gauge 70. The measuring part 22 measures each position to be measured while moving the probe 12 in the X-axis direction, the Y-axis direction, and the Z-axis direction, for example. The measuring part 22 measures coordinates of the plurality of positions to be measured in each of a plurality of portions to be examined 71 (details will be described later) of the inspection gauge 70. The measuring part 22 generates position data indicating the plurality of positions to be measured.

The measuring part 22 generates distance data indicating a distance to be measured that is a distance between the plurality of positions to be measured indicated by the position data. In a case where the center position of each portion to be examined 71 is used as each position to be measured, each position to be measured is measured on the basis of coordinates of a plurality of positions where the tip of the probe 12 has contacted the surface of each portion to be examined 71. The distance to be measured is a distance between the centers of each of two spheres among a plurality of spheres (sphere-to-sphere distance), for example.

The measuring part 22 may calculate the distance to be measured by correcting the distance between the plurality of positions to be measured on the basis of the temperature of the measurement space. For example, the measuring part 22 may perform the above-described correction on the basis of the temperature of the measurement space by referencing a storage part that stores identification information of a plurality of inspection gauges and information indicating changes in the length of each inspection gauge due to changes in temperature, in association with each other.

### (The Gauge Moving Apparatus 50)

The gauge moving apparatus 50 has a robot arm 51 and a control device 55. The gauge moving apparatus 50 is connected to the three-dimensional measuring apparatus 10 in a manner enabling communication. The gauge moving apparatus 50 is connected to the three-dimensional measuring apparatus 10 via a network, for example.

The robot arm 51 holds the inspection gauge 70 (described in detail later). The robot arm 51 is an articulated arm having a built-in actuator, for example. The robot arm 51 holds the inspection gauge 70 in a predetermined posture in the measurement space of the three-dimensional measuring apparatus 10.

When holding the inspection gauge 70, the robot arm 51 itself may autonomously move to hold the inspection gauge 70 arranged at a predetermined position, or a user may attach the inspection gauge 70 to the robot arm 51.

The control device 55 is a computer that controls the operation of each part of the gauge moving apparatus 50. As shown in FIG. 2, the control device 55 has a communication part 56 and an arm control part 57.

The communication part 56 includes a communication device for transmitting and receiving information via a network, for example. The communication part 56 acquires a gauge ID for identifying the inspection gauge 70 and an apparatus ID for identifying the target three-dimensional measuring apparatus 10, for example. The communication part 56 also acquires an examination ID indicating types of examinations. The communication part 56 may acquire the gauge ID input by an operator, or may acquire the gauge ID by reading an identification tag attached to the inspection gauge 70, with a sensor. The communication part 56 acquires the apparatus ID transmitted by the three-dimensional measuring apparatus 10 connected to the gauge moving apparatus 50, for example.

The communication part 56 transmits, to the three-dimensional measuring apparatus 10, an arrangement completion notification indicating that the inspection gauge 70 has been arranged in a predetermined posture. The communication part 56 receives a measurement completion notification indicating that measurement of the portion to be examined of the inspection gauge 70 has been completed, which has been transmitted by the three-dimensional measuring apparatus 10.

The arm control part 57 identifies posture information of the inspection gauge 70 on the basis of one or more of the gauge ID, the apparatus ID, and the examination ID acquired by the communication part 56. The “posture information of the inspection gauge” is information indicating the plurality of postures in which a predetermined inspection gauge should be held when acquiring the calibration data of the three-dimensional measuring apparatus 10 using the predetermined inspection gauge. The “posture information of the inspection gauge” includes information of postures from a first posture to an n-th posture (n is an integer) according to types of inspection. For example, if daily inspection and detailed inspection are set as the types of inspection, the number of postures in the detailed inspection is larger than the number of postures in the daily inspection. The arm control part 57 controls the robot arm 51 so that the inspection gauge 70 is sequentially held in the plurality of postures in accordance with the identified posture information of the inspection gauge.

### (The Inspection Gauge 70)

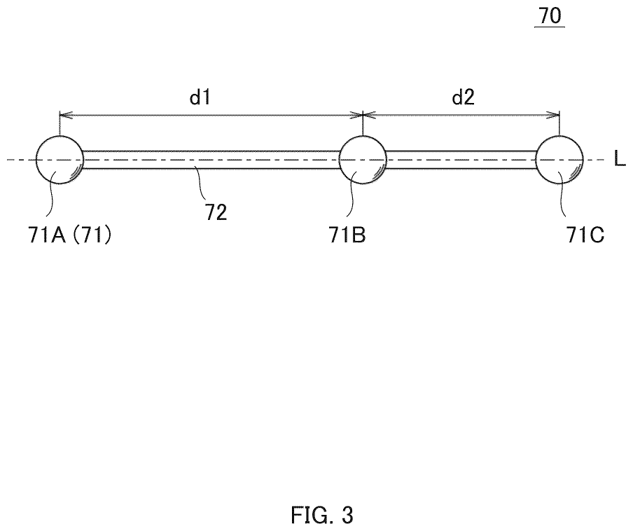

FIG. 3 shows an example of the inspection gauge 70. The inspection gauge 70 has the plurality of portions to be examined 71 and a support 72. The inspection gauge 70 has a configuration in which the plurality of portions to be examined 71 and the support 72 are integrally formed, for example. In the example of FIG. 3, a first portion to be examined 71A, a second portion to be examined 71B, and a third portion to be examined 71C are provided as the plurality of portions to be examined 71.

All of the first portion to be examined 71A, the second portion to be examined 71B, and the third portion to be examined 71C are spheres having the same shape, and are arranged at predetermined intervals from each other, for example. The first portion to be examined 71A and the third portion to be examined 71C are arranged at the ends of the support 72. The support 72 does not penetrate the first portion to be examined 71A and the third portion to be examined 71C, and does not project from the first portion to be examined 71A and the third portion to be examined 71C. The second portion to be examined 71B is arranged between the first portion to be examined 71A and the third portion to be examined 71C.

The first portion to be examined 71A, the second portion to be examined 71B, and the third portion to be examined 71C are arranged on a straight line along the extending direction of the support. Specifically, the first portion to be examined 71A, the second portion to be examined 71B, and the third portion to be examined 71C are arranged such that the centers of the respective spheres are positioned on a reference line L, which is a straight line. In this example, a distance dl between the first portion to be examined 71A and the second portion to be examined 71B is different from a distance d2 between the second portion to be examined 71B and the third portion to be examined 71C, and is longer than the distance d2.

The support 72 is a rod-shaped member extending along the reference line L. The support 72 is a rod extending linearly, as an example. The cross-sectional shape of the support 72 may be any of a circle, a rectangle, or a polygon. The support 72 may be a hollow member or a solid member. The support 72 may be formed to have the same cross-sectional shape in its length direction. The material of the support 72 is the same in the entire region of the support 72, for example, and is metal, as an example.

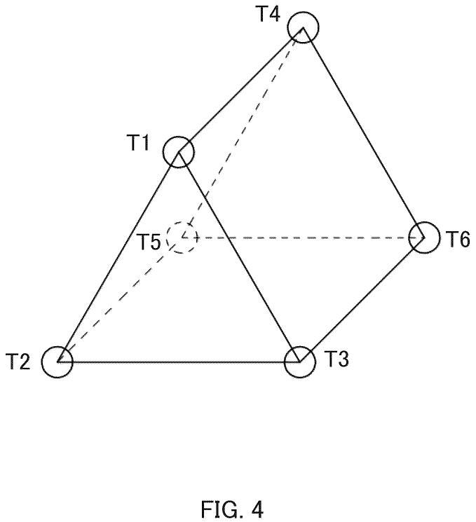

FIG. 4 shows an example of a conventional inspection gauge. In the inspection gauge of FIG. 4, spheres T1 to T6, which are portions to be examined, are arranged at each vertex of a regular triangular prism. Conventionally, in the three-dimensional measuring apparatus 10, calibration data is acquired using an inspection gauge as shown in FIG. 4, for example. In the present embodiment, it is possible to acquire similar calibration data with a simple inspection gauge such as the inspection gauge 70. The distance d1 of the inspection gauge 70 may correspond to the distance between the sphere T2 and the sphere T6 (the length of a diagonal line of a side surface of the triangular prism), for example. The distance d2 of the inspection gauge 70 may correspond to the distance between the sphere T2 and the sphere T3 (the length of one side of the bottom surface of the triangular prism), for example.

### (The Calibration Data Acquisition Method)

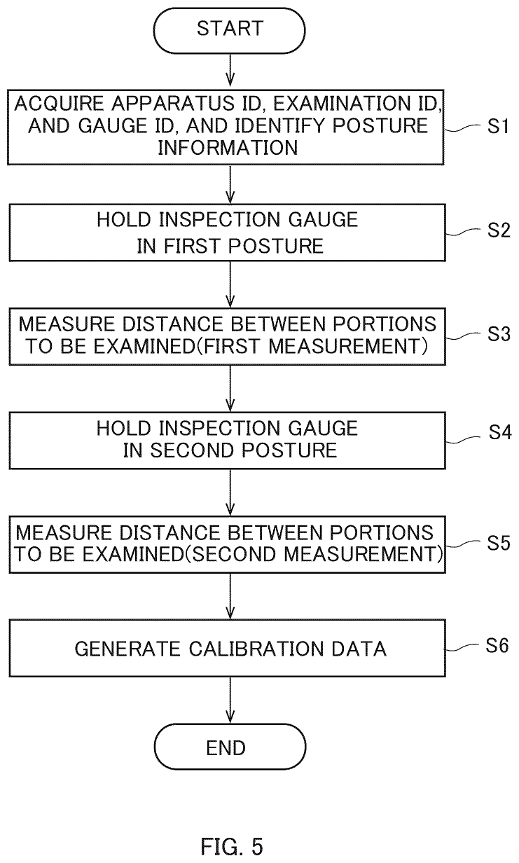

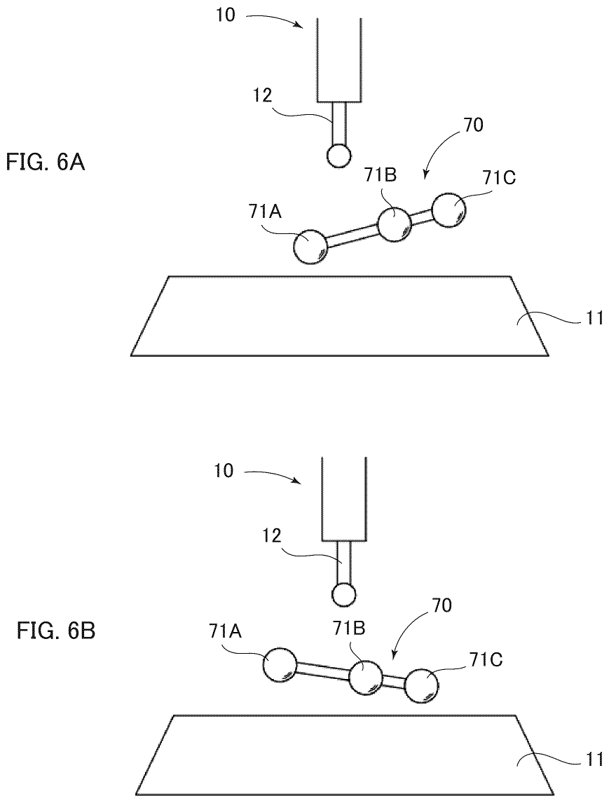

FIG. 5 is a flowchart of an example of a calibration data acquisition method using the inspection gauge 70 of FIG. 4. FIGS. 6A and 6B are each a schematic diagram for explaining the calibration data acquisition method. First, in step S1, the control device 55 of the gauge moving apparatus 50 acquires the apparatus ID of the target three-dimensional measuring apparatus 10, the examination ID of the examination to be performed, and the gauge ID of the inspection gauge 70 to be used. The control device 55 identifies posture information of the inspection gauge 70 on the basis of the acquired apparatus ID, examination ID, and gauge ID.

Next, in step S2, the robot arm 51 holds the inspection gauge 70 in the first posture indicated by the posture information, in the measurement space of the three-dimensional measuring apparatus 10 (see FIG. 6A). Thereafter, the control device 55 transmits, to the three-dimensional measuring apparatus 10, an arrangement completion notification indicating that the inspection gauge 70 has been arranged in the first posture.

The orientations of the inspection gauge 70 depicted in FIGS. 6A and 6B are shown as a reference, and does not limit the orientation of the inspection gauge 70 in the present disclosure. As an example, the “first posture” of the inspection gauge 70 may be a posture in which the first portion to be examined 71A and the second portion to be examined 71B are respectively at positions corresponding to the sphere T2 and the sphere T6 of the inspection gauge of FIG. 4, which is placed on the table.

Next, in step S3, in response to the control unit 20 of the three-dimensional measuring apparatus 10 receiving the arrangement completion notification from the control device 55, the three-dimensional measuring apparatus 10 measures the distance between the plurality of portions to be examined 71 of the inspection gauge 70 in the first posture. Thereafter, the control unit 20 transmits, to the gauge moving apparatus 50, a measurement completion notification indicating that the measurement has been completed.

Next, in step S4, in response to the control device 55 receiving the measurement completion notification from the three-dimensional measuring apparatus 10, the robot arm 51 holds the inspection gauge 70 in a second posture that is different from the first posture, in the measurement space of the three-dimensional measuring apparatus 10 (see FIG. 6B). Thereafter, in a similar manner as in step S2, the control device 55 transmits an arrangement completion notification to the three-dimensional measuring apparatus 10.

As an example, the “second posture” may be a posture in which the second portion to be examined 71B and the third portion to be examined 71C are at positions corresponding respectively to the sphere T2 and the sphere T3 of the inspection gauge of FIG. 4, which is placed on the table.

Next, in step S5, in a similar manner as in step S3, the three-dimensional measuring apparatus 10 measures the distance between the portions to be examined 71 of the inspection gauge 70 in the second posture.

Next, in step S6, the control unit 20 generates calibration data including at least i) first distance data that is the distance measured in step S3 and ii) second distance data that is the distance measured in step S5. In this manner, calibration data necessary for calibrating the three-dimensional measuring apparatus 10 is acquired.

Although the inspection gauge 70 is held in the first posture and the second posture in the flowchart of FIG. 5, the inspection gauge 70 may be held in more postures and the distance between the portions to be examined 71 in each posture may be measured.

### Effects of the Present Embodiment

According to the above-described configuration, the three-dimensional measuring apparatus 10 measures the positions to be measured in each posture while holding the inspection gauge 70 in a plurality of postures with the robot arm 51, so that the inspection gauge having a complicated structure such as in the conventional art or FIG. 4 is not necessary, which makes it possible to simplify the inspection gauge 70.

In addition, according to the inspection gauge 70 of the present embodiment, i) a first distance d1 between the first portion to be examined 71A and the second portion to be examined 71B and ii) a second distance d2 between the second portion to be examined 71B and the third portion to be examined 71C are different from each other, and therefore it is possible to measure three distances of i) the first distance d1, ii) the second distance d2, and iii) a distance that is the sum of the first distance dl and the second distance d2, with one inspection gauge 70.

### Second Embodiment

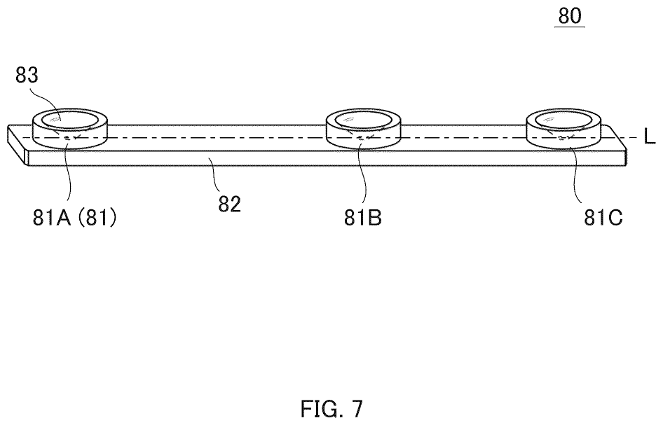

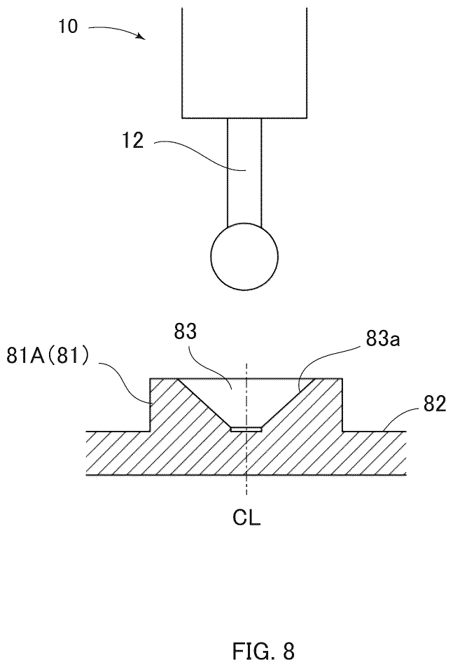

FIG. 7 shows an inspection gauge according to a second embodiment. FIG. 8 is a cross-sectional view of a part of the inspection gauge of FIG. 7. An inspection gauge 80 of FIG. 7 has a plurality of portions to be examined 81 and a support 82. The support 82 is a member having a rectangular cross-sectional shape, as an example.

A first portion to be examined 81A, a second portion to be examined 81B, and a third portion to be examined 81C are provided as the plurality of portions to be examined 81. The first portion to be examined 81A, the second portion to be examined 81B, and the third portion to be examined 81C are arranged such that their positions to be measured are positioned on a reference line L, which is a straight line. In a similar manner as in the first embodiment, the distance between the first portion to be examined 81A and the second portion to be examined 81B is longer than the distance between the second portion to be examined 81B and the third portion to be examined 81C.

Since each portion to be examined 81 has the same shape, its structure will be described below by taking the first portion to be examined 81A as an example. As shown in FIG. 8, a recess 83 having a truncated cone shape is formed in the portion to be examined 81. By bringing the tip of the probe 12 into contact with an inner peripheral surface 83a of the recess 83, it is possible to measure the position to be measured of the portion to be examined 81. The three-dimensional measuring apparatus 10 moves the probe 12 toward the portion to be examined 81 so that the sphere at the tip of the probe 12 is positioned at the center CL of the portion to be examined 81, and measures coordinates of a position where the sphere has contacted the inner peripheral surface 83a.

Specifically, the three-dimensional measuring apparatus 10 moves the probe 12 to measure each position to be measured through a function called a “measurement to find the apex of the conical locus”. The “measurement to find the apex of the conical locus” is a method in which the tip of the probe 12 is caused to trace a measurement surface, and a moving direction of a contact point is determined continuously while observing the small displacement vector of the contact point, thereby autonomously finding a moving path and measuring a measurement reference position.

According to the method of measuring each position to be measured by bringing the tip of the probe 12 into contact with the inner peripheral surface 83a of the truncated cone-shaped recess 83 as described above, it is possible to measure each position to be measured in a short time as compared with the method of bringing the tip of the probe 12 into contact with a plurality of portions on the outer peripheral surface of the sphere.

Although FIGS. 7 and 8 show the inspection gauge 80 in which the truncated cone-shaped recess is formed, the portion to be examined 81 of the inspection gauge 80 may have a cone-shaped recess.

### (Method of Using the Inspection Gauge 80)

Also in the case of calibrating the three-dimensional measuring apparatus 10 using the inspection gauge 80 shown in FIGS. 7 and 8, the inspection gauge 80 may be held in a plurality of postures with the robot arm 51, and the position of the portion to be examined 81 in each posture may be measured, in a similar manner as in the flowchart of FIG. 5.

However, in the case of using the inspection gauge 80, it is impossible to measure the position to be measured of the portion to be examined 81 if the inspection gauge 80 is not arranged in an orientation in which the probe 12 can move toward the recess 83 of the portion to be examined 81, unlike the inspection gauge 70 in which the portion to be examined 71 is a sphere. Therefore, in the step of holding the inspection gauge 80, the robot arm 51 holds the inspection gauge 80 so that the opening of the recess 83 faces the probe 12. According to such a configuration, the three-dimensional measuring apparatus 10 can measure the position to be measured by bringing the tip of the probe 12 into contact with the recess 83 well.

### Variation Example 1

The gauge moving apparatus 50 may be configured to selectively use the inspection gauge 70 of FIG. 3 as a first inspection gauge and the inspection gauge 80 of FIG. 7 as a second inspection gauge. For example, the gauge moving apparatus 50 may be configured to autonomously operate the robot arm 51 to hold the inspection gauge 70 or the inspection gauge 80 from a gauge receptacle in which a plurality of inspection gauges are disposed.

As described above, comparing the inspection gauge 70 of FIG. 3 to the inspection gauge 80 of FIG. 7, the inspection gauge 80 has an advantage that it is possible to measure the position to be measured in a short time. Therefore, in a case where both of these inspection gauges are available, the gauge moving apparatus 50 may preferentially use the inspection gauge 80, as an example. However, in the inspection gauge 80, it is necessary to measure the position to be measured by bringing the tip of the probe 12 into contact with the recess 83 of the portion to be examined 81, and it is necessary for the three-dimensional measuring apparatus 10 to have an operation mode for measuring the position to be measured by bringing the tip of the probe 12 into contact with the recess 83 (e.g., a “measurement to find the apex of the conical locus” mode). In a case where the three-dimensional measuring apparatus 10 does not have such an operation mode, it is necessary to use the inspection gauge 70 because the inspection gauge 80 cannot be used.

Therefore, the three-dimensional measuring apparatus 10 and the gauge moving apparatus 50 may be configured as follows so that an inspection gauge suitable for the target three-dimensional measuring apparatus 10 is selected from among a plurality of types of inspection gauges.

For example, the arm control part 57 (see FIG. 2) of the gauge moving apparatus 50 determines whether or not the three-dimensional measuring apparatus 10 has an operation mode for measuring a cone-shaped or truncated cone-shaped position to be measured, on the basis of operation mode information of the probe that the communication part 56 received from the three-dimensional measuring apparatus 10. In a case where the three-dimensional measuring apparatus 10 does not have the operation mode for measuring a cone-shaped or truncated cone-shaped position to be measured, the arm control part 57 causes the robot arm 51 to hold the inspection gauge 70.

According to such a configuration, since the gauge moving apparatus 50 autonomously selects the inspection gauge 70, which is the first inspection gauge, in a case where the three-dimensional measuring apparatus 10 does not have the operation mode corresponding to the inspection gauge 80, it is not necessary for the operator to input information concerning the operation mode of the three-dimensional measuring apparatus 10, to the gauge moving apparatus 50 or the like.

It should be noted that the arm control part 57 may determine the operation mode of the three-dimensional measuring apparatus 10 by refencing the storage part that stores i) a plurality of apparatus IDs and ii) a plurality of pieces of operation mode information of an apparatus indicated by each apparatus ID (e.g., information concerning whether or not the operation mode for measuring a cone-shaped or truncated cone-shaped position to be measured is included) in association with each other, on the basis of the apparatus ID that the communication part 56 received from the three-dimensional measuring apparatus 10. In a case where the three-dimensional measuring apparatus corresponding to the acquired apparatus ID does not have the operation mode, the arm control part 57 causes the robot arm 51 to hold the inspection gauge 70, which is the first inspection gauge. The arm control part 57 of the gauge moving apparatus 50 may acquire the above-described apparatus ID from equipment other than the three-dimensional measuring apparatus 10.

### Variation Example 2

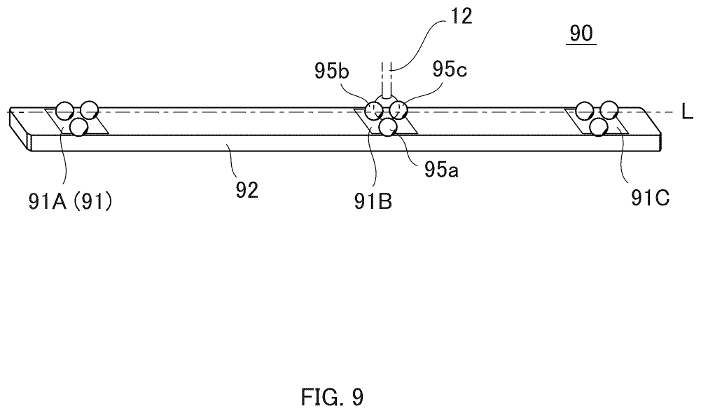

The inspection gauge is not limited to the configuration shown in FIGS. 3 and 4, and may have a configuration as shown in FIG. 9. FIG. 9 shows a variation example of the inspection gauge. An inspection gauge 90 of FIG. 9 has a plurality of portions to be examined 91 and a support 92. Since the support 92 has the same structure as the support 82 of FIG. 4, the description thereof will be omitted.

A first portion to be examined 91A, a second portion to be examined 91B, and a third portion to be examined 91C are provided as the plurality of portions to be examined 91. Since all of the first portion to be examined 91A, the second portion to be examined 91B, and the third portion to be examined 91C have the same structure, the second portion to be examined 91B will be described as an example.

This portion to be examined 91 has three spherical elements 95a, 95b, and 95c that the sphere at the tip of the probe 12 contacts. All of the spherical elements 95a, 95b, and 95c are spheres having the same size, for example, and are fixed to the upper surface of the support 92. The spherical elements 95a, 95b, and 95c are provided at positions such that the spherical elements 95a, 95b, and 95c contact the sphere of the probe 12 to prevent the probe 12 from moving any farther when the sphere of the probe 12 approaches from above (in this state, the sphere of the probe 12 does not contact the upper surface of the support 92).

In a similar manner as the above-described inspection gauge 70 and inspection gauge 80, the inspection gauge 90 is also positioned in a plurality of postures in the measurement space of the three-dimensional measuring apparatus 10 by the robot arm 51, and the position of the portion to be examined 91 in each posture is measured by the three-dimensional measuring apparatus 10, so that it is possible to acquire calibration data for calibrating the three-dimensional measuring apparatus 10 well.

In the inspection gauges of FIGS. 3 and 7, three portions to be examined are provided, but more portions to be examined may be provided, or only two portions to be examined may be provided. A plurality of portions to be examined may be arranged such that the distance d1 (see FIG. 3) and the distance d2 are the same.

The present invention is explained on the basis of the exemplary embodiments. The technical scope of the present invention is not limited to the scope explained in the above embodiments and it is possible to make various changes and modifications within the scope of the invention. For example, all or part of the apparatus can be configured with any unit which is functionally or physically distributed or integrated. Further, new exemplary embodiments generated by arbitrary combinations of them are included in the exemplary embodiments of the present invention. Further, effects of the new embodiment brought by the combinations also have the effect of the original exemplary embodiment together.

1. A calibration data acquisition method, comprising:
a first holding, including at least holding an inspection gauge provided with a plurality of portions to be examined in a first posture with a gauge moving apparatus, in a measurement space of a three-dimensional measuring apparatus;
a first measuring, including at least acquiring first distance data by measuring a distance between the plurality of portions to be examined of the inspection gauge in the first posture, with the three-dimensional measuring apparatus;
a second holding, including at least holding the inspection gauge in a second posture that is different from the first posture with the gauge moving apparatus, after the first measuring;
a second measuring, including at least acquiring second distance data by measuring a distance between the plurality of portions to be examined of the inspection gauge in the second posture, with the three-dimensional measuring apparatus; and
generating calibration data including at least the first distance data and the second distance data.

2. The calibration data acquisition method according to claim 1, wherein
the inspection gauge is a first inspection gauge having a support and a plurality of spheres provided on the support at predetermined intervals as the plurality of portions to be examined, and
the first measuring and the second measuring measure a center position of each sphere by bringing a tip of a probe of the three-dimensional measuring apparatus into contact with each sphere.

3. The calibration data acquisition method according to claim 1, wherein
the inspection gauge is a second inspection gauge having a support and a plurality of portions to be examined that are provided on the support at predetermined intervals as the plurality of portions to be examined, and each of which has a cone-shaped or truncated cone-shaped recess, and
the first measuring and the second measuring measure a cone-shaped or truncated cone-shaped position to be measured by bringing a tip of a probe of the three-dimensional measuring apparatus into contact with an inner peripheral surface of the recess.

4. The calibration data acquisition method according to claim 3, wherein
the first holding and the second holding hold the second inspection gauge with the gauge moving apparatus so that an opening of the recess faces the probe.

5. The calibration data acquisition method according to claim 1, wherein
the gauge moving apparatus is configured to selectively use one of i) a first inspection gauge having a support and a plurality of spheres provided on the support at predetermined intervals or ii) a second inspection gauge having a support and a plurality of portions to be examined provided on the support at predetermined intervals, each portion to be examined having a cone-shaped or truncated cone-shaped recess, and
the first measuring or the second measuring uses the first inspection gauge with the gauge moving apparatus in response to a determination that the three-dimensional measuring apparatus does not have an operation mode of a probe for measuring a cone-shaped or truncated cone-shaped position to be measured.

6. The calibration data acquisition method according to claim 5, further comprising:
acquiring operation mode information of the probe from the three-dimensional measuring apparatus, thereby determining whether or not the three-dimensional measuring apparatus has the operation mode for measuring the cone-shaped or truncated cone-shaped position to be measured, with the gauge moving apparatus.

7. The calibration data acquisition method according to claim 5, further comprising:
with the gauge moving apparatus, acquiring an apparatus ID for identifying the three-dimensional measuring apparatus, referencing, on the basis of the acquired apparatus ID, a storage part that stores i) a plurality of apparatus IDs and ii) a plurality of pieces of information concerning whether or not the three-dimensional measuring apparatus has the operation mode for measuring the cone-shaped or truncated cone-shaped position to be measured, in association with each other, and, in response to a determination that a three-dimensional measuring apparatus corresponding to the acquired apparatus ID does not have the operation mode, causing a robot arm to hold the first inspection gauge.

8. An inspection gauge comprising:
a support, and
a plurality of portions to be examined provided on the support such that the plurality of portions to be examined are arranged on a straight line along an extending direction of the support, wherein
the plurality of portions to be examined include a first portion to be examined, a second portion to be examined, and a third portion to be examined, and i) a first distance between the first portion to be examined and the second portion to be examined and ii) a second distance between the second portion to be examined and the third portion to be examined are different from each other.

9. The inspection gauge according to claim 8, wherein
each portion to be examined is a sphere.

10. The inspection gauge according to claim 8, wherein
each portion to be examined has a cone-shaped or truncated cone-shaped recess.

11. The inspection gauge according to claim 8, wherein
each portion to be examined includes three spherical elements that a sphere at a tip of a probe of a three-dimensional measuring apparatus contacts.
